(19) United States
(12) Patent Application Publication
(10) Pub. No.: US 2026/0309524 A1
(43) Pub. Date: Oct. 8, 2026

(54) SENSOR FOR PROCESS AND AUTOMATION ENGINEERING

(71) Applicants: IFM ELECTRONIC GMBH, Essen (DE); AUTOSEN GMBH, Essen (DE)

(72) Inventors: Benno KATHAN, Kressbronn (DE); Konrad BONK, Essen (DE); Jürgen HEINRICH, Rosenheim (DE); Alexander KNÖRLE, Bad Waldsee (DE)

(73) Assignees: IFM ELECTRONIC GMBH, Essen (DE); AUTOSEN GMBH, Essen (DE)

(21) Appl. No.: 19/481,653

(22) PCT Filed: May 16, 2024
(86) PCT No.: PCT/EP2024/063513

§ 371 Date: Nov. 5, 2025

(30) Foreign Application Priority Data
May 25, 2023 (DE) 10 2023 113 806.5

(51) Int. Cl. G01D 11/24

(52) U.S. Cl. CPC G01D 11/245

(57) ABSTRACT

A sensor for process and automation engineering, includes releasably connected individual modules, wherein a sensor unit is in a first module and an electronics unit is in a second module, and housings of both modules have congruent bases connected at a front side to a sensor. A first housing base has an annular protrusion with a radially outwardly bulge, and a second housing base has a complementary annular recess with an indentation complementary to and engaging the bulge by twisting the two housings towards each other, thereby creating a releasable locking mechanism. An elastic sealing element seals both housings and is preloaded by contact with the annular protrusion by the push-and-twist movement, whereby the bulge is pressed in the axial direction against the wall of the indentation, such that the push-and-twist movement allows both housings to be connected to each other simultaneously in a form-fitting and frictionally engaged manner.

The invention relates to a sensor for process and automation engineering, which consists of at least two individual modules, which each comprise their own housing and are releasably connected to each other.

A sensor or measuring device for process and automation technology is used to record a physical quantity and essentially comprises a sensor element, an electronic unit for evaluating and/or processing the measurement signals generated by the sensor element, and an electrical interface via which the measuring device is supplied with energy, and the generated measurement signals can be tapped by a higher-level control unit.

The sensor element, also known as a measurement transducer, is used to record and convert a physical measured value of a process value into a measurement signal. In process technology, the measuring transducer is used in particular to record pressure, temperature, flow, or fill levels of a medium in a container. In addition, there are other applications in automation technology, wherein optical, capacitive, and inductive proximity switches and sensors as well as vibration monitoring are cited here by way of example.

In specific applications, the need has arisen to spatially separate at least the aforementioned individual modules, sensor element and electronics unit, as is known, for example, from DE 10 2018 121 463 A1 by the applicant. Accordingly, a separate housing must be provided for each individual module. In the event that these individual modules are not to be arranged at a spacing from each other, but are to be separated but still connected to each other as a compact overall sensor, the housings of the individual modules must be securely and rigidly connected to each other.

The object of the invention is to rigidly and releasably connect the individual modules of a multi-part sensor or their housings to each other in a simple manner.

The object is achieved according to the invention by a sensor having the features of claim 1. Advantageous embodiments of the invention are specified in the dependent claims.

According to the invention, the housings of the individual modules are firstly designed with congruent bases so that they can be connected to each other at the front side in such a way that the overall sensor has a compact contour. The base of one housing has an annular protrusion and the base of the other housing has a complementary annular recess. When both individual modules and thus their housings are connected to each other, the annular protrusion and the recess interlock and can therefore be rotated relative to each other within a certain range.

The releasable connection between the two individual modules or two housings is established by a locking mechanism which is formed by at least one radial bulge arranged on the outer circumference of the annular protrusion of the first housing and a complementary indentation at the annular recess of the second housing. Preferably, the radial bulge and the complementary indentation have a sawtooth-like or bolt-like design. The two individual modules are locked and thus axially fixed by the fact that the indentation has an undercut into which the radial bulge engages by the two housings being rotated towards each other.

It is also essential to the invention that an elastic sealing element, for example an O-ring, is arranged in the annular recess in the second housing to seal the two housings. In addition to the sealing function, the sealing element fulfills a second, essential function in that the contact with the annular protrusion of the first housing that occurs as a result of joining the two housings or individual modules causes this sealing ring to be preloaded, whereby the at least one bulge is pressed in the axial direction against the wall of the indentation. The sealing ring is elastically deformed but not compressed, and consequently develops a restoring force. As a result, both housings can be connected to each other simultaneously in a form-fitting and frictionally engaged manner using a simple push-and-twist movement with a very small twisting movement of approximately 10°. This means that when the two housings are assembled, the sealing element generates the necessary contact pressure for the locking mechanism and thus enables a rigid and releasable connection despite the few degrees or rotational movement.

In addition, the sealing element fulfills a third function in that it acts in a damping and thus shock-absorbing manner.

Even if the bulge and the complementary indentation are preferably described as being sawtooth-like or bolt-like, the invention in principle encompasses all configurations which are suitable for locking and thus axially fixing the two individual modules by moving the bulge into the undercut.

Advantageously, the locking mechanism is formed by four radial bulges, preferably offset by 90°, and complementary indentations. It is particularly advantageous to provide a mixture of sawtooth-like and bolt-like bulges. This makes it easy to provide a coding system that allows the two housings to be joined together only in a specific position.

A further advantageous development provides that the first housing has a second bulge which, due to the push-and-twist movement, presses a snap hook on the second housing radially outward, thereby forming a locking mechanism. This prevents the locking mechanism from being easily released, as the resistance of the snap hook must first be overcome to perform a reverse movement.

Preferably, the housings of the two modules are cuboid so that the overall sensor has a compact cuboid contour.

In a further preferred embodiment, the bases of the housings are square, wherein the at least one indentation is particularly preferably arranged in one corner or the four indentations are particularly preferably arranged in the corners of the square base. In this way, the bases of the housings can be optimally utilized while having a comparatively thin wall thickness in the region of the side surfaces and the contours can be minimized as far as possible, which is advantageous with regard to a compact design. In addition, the arrangement of the indentations in the corners is also advantageous because at these points, the side surfaces are orthogonal to each other and the construction is therefore at its most rigid there.

The invention is explained in more detail below using exemplary embodiments with reference to the drawings, in which:

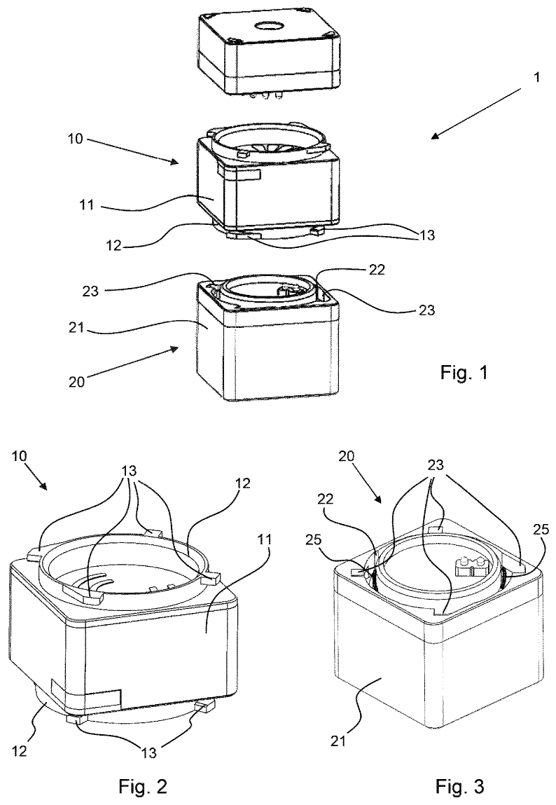

FIG. 1 is an exploded view of the sensor according to the invention, which consists of three individual modules;

FIG. 2 shows a first individual module from the view in FIG. 1;

FIG. 3 shows a second individual module from the view in FIG. 1;

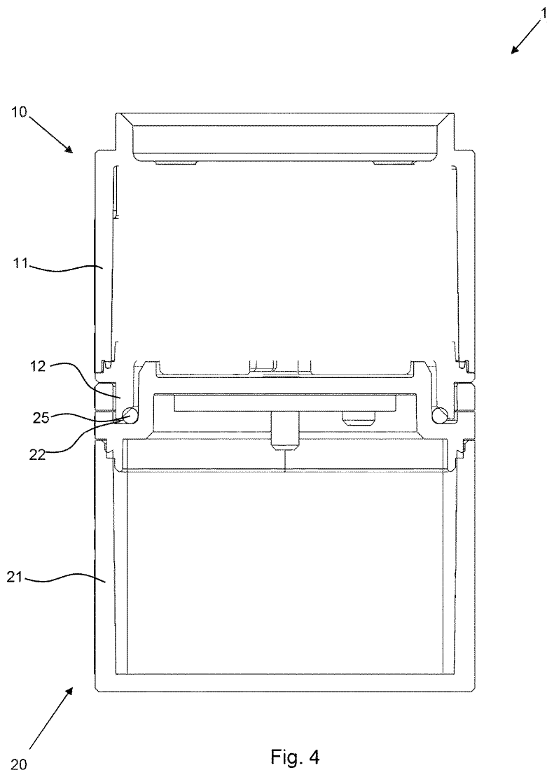

FIG. 4 is a sectional view of the overall sensor according to the invention;

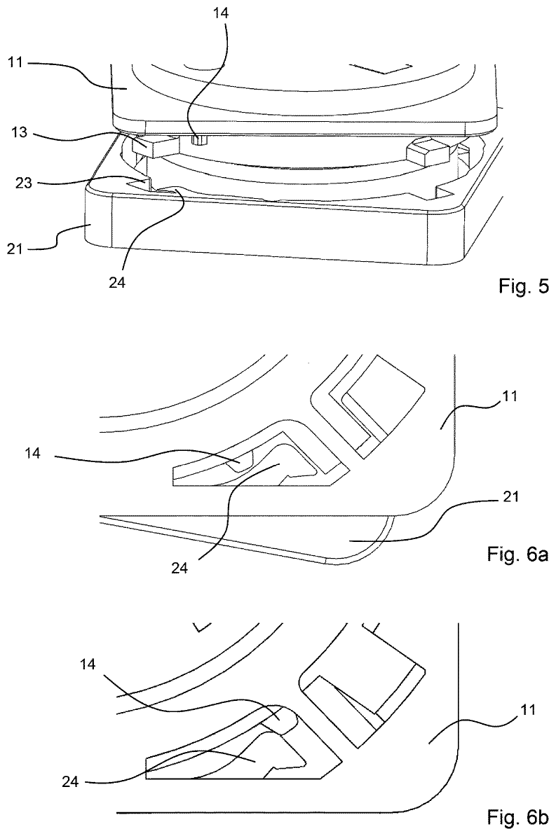

FIG. 5 shows the connection of two individual modules by means of a locking mechanism;

FIG. 6a is a detailed view of the locking mechanism in the open state; and

FIG. 6b is a detailed view of the locking mechanism in the closed state.

In the following description of the preferred embodiments, the same reference signs denote the same or comparable components.

FIG. 1 is an exploded view of the sensor 1 according to the invention, which consists of a total of three individual modules 10, 20. In principle, the invention is initially based on two individual modules 10, 20, but the concept of the invention can be extended to any number of individual modules.

Each individual module 10, 20 consists of a cuboid housing 11, 21 with congruent bases. The individual modules 10, 20 can thus be connected to each other at the front side in such a way that the overall sensor 1 has a compact, cuboid contour. Both the upper and lower bases of the middle housing 11 each have an annular protrusion 12 and the base of the lower housing 21 has a complementary annular recess 22. When both individual modules 10, 20 and thus their housings 11, 21 are connected to each other, the annular protrusion 12 and the recess 22 interlock and they can thus be rotated relative to each other within a certain range.

As a locking mechanism for releasably connecting the two individual modules 10, 20 or two housings 11, 21, four radial bulges 13 arranged on the outer circumference of the annular protrusion 12 and four complementary indentations 23 on the annular recess 22 of the lower housing are provided on the middle housing 11. This is shown again in an enlarged view in the following figures.

In FIGS. 2 and 3, the two individual modules 10, 20 are shown individually and enlarged with respect to FIG. 1. FIG. 2 clearly shows the annular protrusion 12 and the radial bulges 13 arranged on the outer circumference thereof, two of the four bulges 13 having a sawtooth-like design and two having a bolt-like design. Accordingly, the complementary indentations 23 in the region of the annular recess 22 are shown in FIG. 3. Due to the different design of the bulges 13 and indentations 23, a coding system can be realized by which the two housings 11, 21 can only be joined together in a specific position. This is important, for example, for establishing the correct electrical contact between the two individual modules 10, 20. FIGS. 2 and 3 each show electrical contacting elements within the annular protrusion 12 and the annular recess 22, respectively, so that it must be ensured that these are also galvanically connected to each other after the two individual modules 10, 20 have been joined together.

The bases of the housings 11, 21 or individual modules 10, 20 are square and the indentations 23 are arranged in the corners of the square base. In this way, the bases of the housings 11, 21 can be optimally utilized while having a comparatively thin wall thickness in the region of the side surfaces in the second individual module 20 (see FIG. 3) and the contours can be minimized as far as possible, which is advantageous with regard to a compact design. In addition, the arrangement of the indentations in the corners is also advantageous because at these points, the side surfaces are orthogonal to each other and the construction is therefore at its most rigid there.

The two individual modules 10, 20 are locked and axially fixed by the indentations 23 each having an undercut into which the radial bulge 13 engages by the two housings 11, 21 being rotated towards each other. This undercut can be seen in FIG. 3. Also essential is an elastic sealing element 25 arranged in the annular recess 22, which can be designed, for example, as an O-ring. This sealing element 25 serves to seal the two individual modules 10, 20. In addition to the sealing function, the sealing element 25 fulfills a second essential function in that the contact with the annular protrusion 12 which occurs as a result of joining the two housings 11, 21 or individual modules 10, 20 causes this sealing element 25 to be preloaded, as a result of which the at least one bulge 13 is pressed in the axial direction against the wall of the indentation 23. As a result, both housings 11, 21 or individual modules 10, 20 can be connected to each other simultaneously in a form-fitting and frictionally engaged manner using a simple push-and-twist movement with a very small twisting movement of approximately 10°. When the two individual modules 10, 20 are assembled, the sealing element 25 generates the required contact pressure for the locking mechanism and thus enables a rigid and releasable connection despite the few degrees or rotational movement.

FIG. 4 shows an overall view of the sensor 1 according to the invention with the individual modules 10, 20 joined together. This view is intended to clarify in particular the position of the sealing element 25 in the annular recess 22 and the annular protrusion 12 supported on the sealing element 25. Due to the cut in the region of the side surfaces, the locking mechanism itself cannot be seen in FIG. 4.

FIG. 5 shows the locking mechanism as a preferred embodiment of the sensor 1 according to the invention. In addition to the locking mechanism already explained, consisting of the bulge 13 and the indentation 23, there is a further bulge 14 on the upper housing 11, which extends axially in the direction of the lower housing 21.

As can be seen from the views in FIGS. 6a and 6b, this further bulge 14 moves over a snap hook 24 on the lower housing 21 during the push-and-twist movement, whereby the snap hook is pressed radially outward due to its elasticity (see FIG. 6a). When the bulge 13 of the locking mechanism is in the end position in the region of the undercut, the further bulge 14 of the locking mechanism has passed the snap hook 24 so that the snap hook 24 moves back to its original position and thereby presses against the further bulge 14 (see FIG. 6b) so that this and thus the entire upper housing 11 can no longer easily rotate back from the locking position. Only by manual intervention and deliberately overcoming a certain resistance can the two housings 11, 21 be rotated back from the locking position and thus release the connection between the individual modules 10, 20.

### LIST OF REFERENCE SIGNS

1 Sensor
10 First individual module
11 Housing of the first individual module
12 Annular protrusion
13 Radial bulge
14 Second bulge
20 Second individual module
21 Housing of the second individual module
22 Annular recess
23 Indentation
24 Snap hook
25 Elastic sealing element

1. A sensor for process and automation technology, comprising:
at least two individual modules, which each comprise a respective housing and are releasably connected to each other,
wherein a sensor unit is disposed in a first module and an electronics unit is disposed in a second module,
wherein the housings of both modules have congruent bases so that the housings can be connected to each other at a front side of the modules in such a way that the sensor has a compact contour,
wherein the base of a first housing has an annular protrusion and the base of a second housing has a complementary annular recess, the two of which interlock when the sensor is connected,
wherein the releasable connection is established by a locking mechanism which is formed by at least one radial bulge disposed on the outer circumference of the annular protrusion of the first housing and a complementary indentation at the annular recess of the second housing,
wherein the indentation has an undercut into which the radial bulge engages by a push-and-twist movement of the two housings, and
wherein an elastic sealing element is disposed in the annular recess of the second housing to seal both housings, which sealing element is suitable to be preloaded by contact with the annular protrusion of the first housing as a result of the push-and-twist movement, whereby the at least one bulge is pressed in the axial direction against a wall of the indentation such that the push-and-twist movement allows both housings to be connected to each other simultaneously in a form-fitting and frictionally engaged manner.

2. The sensor according to claim 1,
wherein the radial bulge and the complementary indentation have a sawtooth-like or shape or a bolt-like shape.

3. The sensor according to claim 1, wherein the locking mechanism is formed by four radial bulges and complementary indentations.

4. The sensor according to claim 1, wherein the first housing has a second bulge which, as a result of the push-and-twist movement, presses a snap hook on the second housing radially outward, thereby forming a locking mechanism.

5. The sensor according to claim 1, wherein the housings of the two modules are cuboid-shaped.

6. The sensor according to claim 1, wherein the bases of the housings are square.

7. The sensor according to claim 6, wherein the at least one indentation disposed in a corner of each square base.

8. The sensor according to claim 1, wherein the two housings perform a 10° push-and-twist movement.
